(19) United States
(12) Patent Application Publication
(10) Pub. No.: US 2010/0255256 A1
(43) Pub. Date: Oct. 7, 2010

(54) PANEL COMPRISING INSULATING FOAM CORE

(76) Inventors: James Carolan, County Cavan (IE); Gregory Flynn, County Louth (IE)

Correspondence Address: JACOBSON HOLMAN PLLC, 400 SEVENTH STREET N.W., SUITE 600, WASHINGTON, DC, 20004, US

(21) Appl. No.: 12/735,029

(22) PCT Filed: Dec. 15, 2008
(86) PCT No.: PCT/IE2008/000121

§ 371 Date: Jun. 10, 2010

(30) Foreign Application Priority Data
Dec. 14, 2007 (IE) 2007/0909

(51) Int. Cl. E04C 2/292; B32B 27/00; E04D 3/35; B32B 37/14

(52) U.S. Cl. 428/158; 428/316.6; 156/79

(57) ABSTRACT

An insulating panel 1 comprises a first sheet 2 with trapezoidal formations 12 and a second sheet 3. There is an insulating core 4 comprising a main polymeric foam body 4, such as of polyisocyansurate or phenolic foam, and a recycled foam portion. The recycled foam portion is of substantially the same formulation as that of the main foam body. Shredded foam pieces 25 are directly incorporated into the panel, for example into one or more of the profiled recesses 12 defined by crowns in the sheet 2. In the invention the recycled foam portion is introduced prior to lay-down of liquid foam reactants to ensure that the recycled foam portion is integrated into the main foam body.

The invention relates to a panel of the type comprising an external sheet and a backing sheet with an insulating foam core therebetween. Such panels are widely used for walls, roofs and/or floors of buildings.

One of the problems with manufacture of such panels, is that a large amount of waste panels can be generated due to various problems that can arise during manufacture of the panels. Currently such waste panels must be disposed of leading to substantial waste disposal costs. Such disposal is environmentally undesirable.

There is therefore a need for a system to alleviate at least some of these problems.

### STATEMENTS OF INVENTION

According to the invention there is provided an insulating panel comprising a first sheet, a second sheet and an insulating foam core between the first and the second sheets, the insulating foam core comprising a main foam body and a recycled foam portion within the foam body.

Preferably the recycled foam portion is of substantially the same formulation as that of the main foam body.

The insulating core may be a polyisocyanurate foam core or a phenolic foam core.

In one embodiment the recycled foam portion comprises a plurality of foam pieces.

The foam pieces may have an average dimension of from 5 to 25 mm, typically from 10 to 15 mm.

In one case the foam pieces comprise pellets.

In another embodiment the recycled foam portion comprises a block or briquette.

One of the sheets may be profiled to define at least one recess and the recycled foam portion is located at least partially in the recess.

The external and internal sheets may have joint forming profiled portions. The first sheet may be of sheet metal. The second sheet may be of sheet metal.

In another aspect the invention provides a method for manufacturing an insulating panel of the type comprising a first sheet, a second sheet, and an insulating core of foam material therebetween; the method comprising the steps of:—

conveying a first sheet continuously along a bed;
laying down liquid foam reactants onto the first sheet;
leading a second sheet over the liquid insulating foam reactants; and
heating the assembly thus formed in an oven to allow the foam to expand to form an insulating core between the first and second sheets,
characterised in that a recycled foam portion is introduced prior to heating of the assembly in the oven.

In one embodiment the method comprises delivering the recycled foam portion to the first sheet and subsequently applying liquid foam reactants over the recycled foam portion.

In another embodiment the recycled foam portion is applied after lay down of liquid foam reactants.

In one case the first sheet is profiled to define at least one recess and the recycled foam is delivered into the recess.

The recycled foam portion may comprise a plurality of foam pieces which are introduced to the first sheet.

In one embodiment the foam pieces are delivered from a hopper through a chute.

In one case the method comprises the step of applying vibrational forces to the chute to assist free flow of the recycled foam pieces.

Alternatively the recycled foam portion comprises a block or briquette which is introduced to the first sheet. In this case the method may comprise the step of applying an adhesive means to at least portion of the first sheet and/or the block and the block is applied to the adhesive means.

The invention also provides an insulating panel when manufactured by a method of the invention.

### BRIEF DESCRIPTION OF DRAWINGS

The invention will be more clearly understood from the following description thereof give by way of example only with reference to the accompanying drawings in which:—

FIG. 1 is a cross sectional view of a panel according to the invention;

FIGS. 2(a) to 2(e) are diagrams illustrating various steps in the manufacture of the panel of FIG. 1;

FIG. 3 is an isometric view of apparatus used to introduce scrap foam into the panel;

FIG. 4 is an elevational view of the apparatus of FIG. 3;

FIG. 5 is a cross sectional, partially isometric view of another panel of the invention; and

FIGS. 6(a) to 6(e) are diagrams illustrating various steps in the manufacture of the panels of FIG. 5.

### DETAILED DESCRIPTION

Referring to the drawings there is illustrated an insulating panel of the invention. The panel 1 is a structural panel comprises a first sheet 2 which may, for example, be of metal such as painted galvanised steel and may be profiled. In this case the first sheet 2 has trapezoidal formations although many different profiles may be utilised. The panel also comprises a second sheet 3 which may also be of metal such as painted galvanised steel. There is an insulating core 4 comprising a main polymeric foam body 4, such as of polyisocyansurate or phenolic foam, and a recycled foam portion.

The recycled foam portion is of substantially the same formulation as that of the main foam body and is produced as follows.

There are some composite foam panels that are rejected for various reasons, for example because they do not meet manufacturing specifications, are damaged in handling, transit or on site. In the invention such waste panels are first shredded to form a mixture of metal and foam. The metal is removed, for example by magnetic means such as by passing the mixture along a magnetic conveyor. The shredded foam pieces are generally irregular in shape and may have an average dimension of 5 mm to 25 mm, ideally about 10 to about 15 mm.

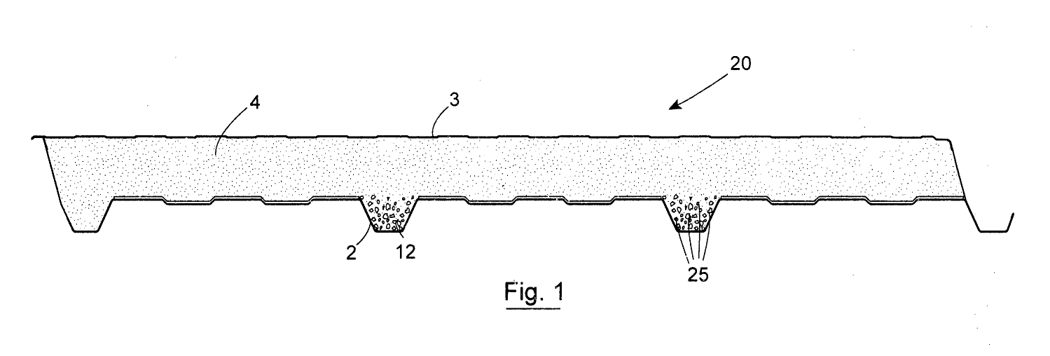

In the case of the panel 1 illustrated in FIG. 1 shredded foam pieces 25 are directly incorporated into the panel, for example into one or more of the profiled recesses 12 defined by crowns in the sheet 2. The level of incorporation/inclusion can be selected to meet specification requirements and may for example be from very low levels such as 1% to high levels such as 50% or possibly more.

Composite panels are manufactured by leading the profiled sheet 2 along a flat bed 35 with the recesses 12 defined by the crowns facing upwards. The profiled sheet 2 is led to a lay-down area at which liquid foam reactants 36 are spread across the sheet 2 using a lay-down poker 37 or the like. As the foam rises the second sheet 3 is applied over the foam and the sandwich thus formed is then led through an oven 38. The manufacturing technology is described in our UK-A-2227712, UK-A-2257086, and UK-A-2325640, the entire contents of which are incorporated herein by reference.

In the invention the recycled foam portion is introduced prior to lay-down of liquid foam reactants to ensure that the recycled foam portion is integrated into the main foam body.

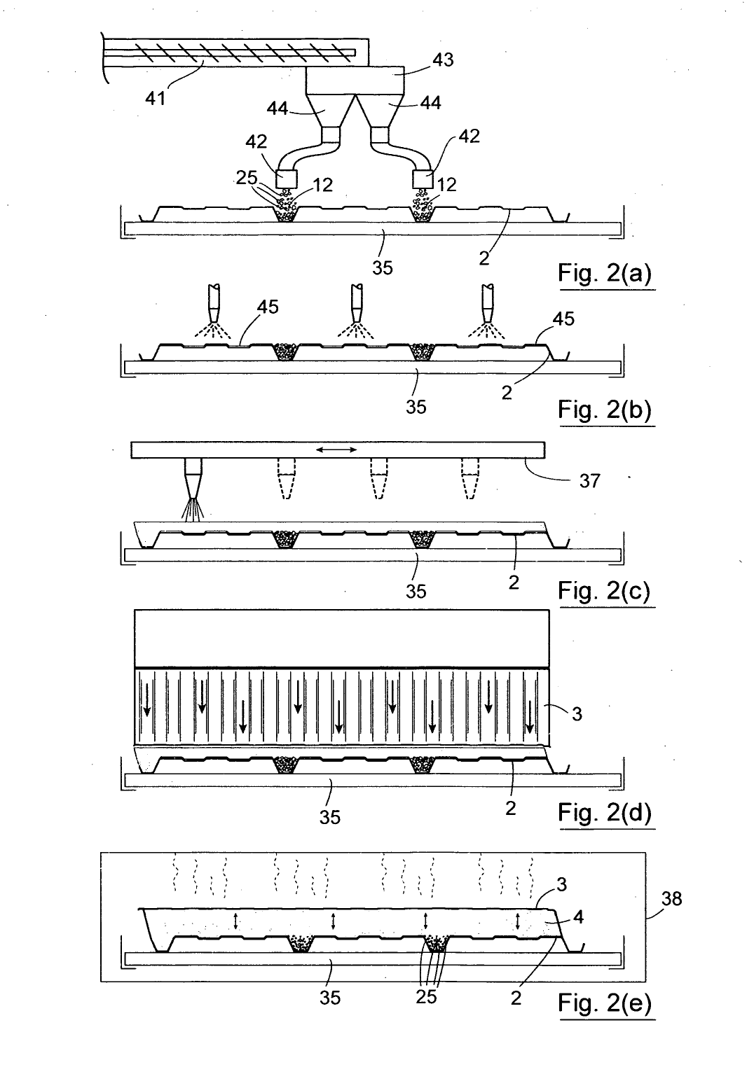

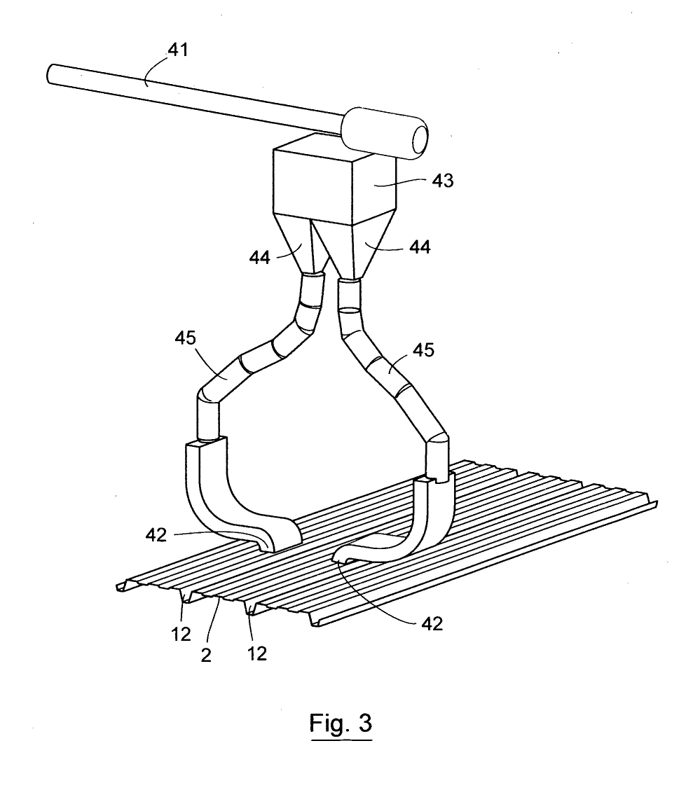

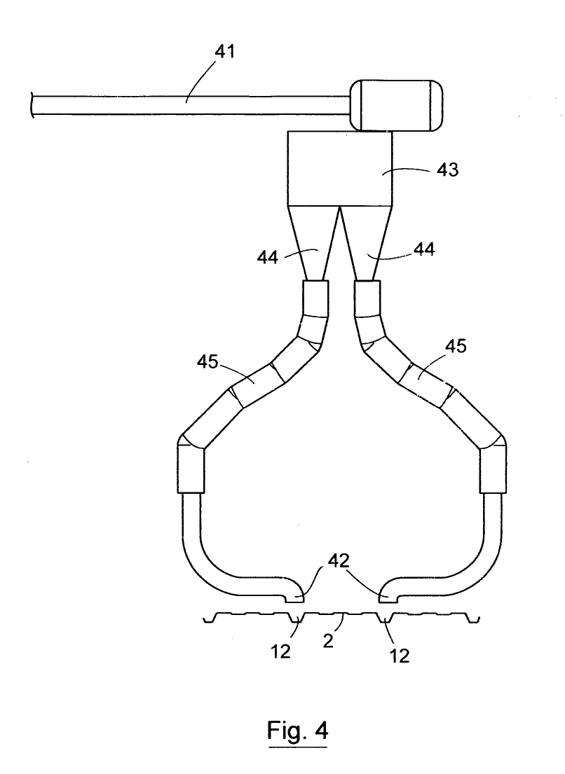

Referring to FIGS. 1 to 4, in one panel 20 according to the invention the recycled foam portion is in the foam of multiple recycled foam pieces 25 which are delivered from a supply hopper through a screw conveyor 41 feeding open nozzles or chutes 42 which deposit the foam pieces into some of the recesses or crowns 12. In this case the conveyor 41 delivers the scrap foam pieces into a hopper 43 with two outlets 44, one associated with each outlet nozzle chute 42. The foam pieces flow by gravity through flexible conduits 45. The arrangement ensures minimum risk of blockage of the chutes 42. In addition, vibration applying elements are mounted on the chute outlets 42 to further ensure the free flow of foam pieces. As a further precaution a vision system may also be used to monitor the flow of foam pieces into the crowns/recesses 12. A pre-laydown foam/adhesive layer 45 may be applied on top of the exposed surfaces of the sheet 2 and, if desired over the deposited foam pieces 25. A pre-laydown layer may also be applied to the recesses/crowns 12 before deposition of the foam pieces 25. The inclusion of a pre-laydown adhesive/foam assists in retaining the foam pieces. On lay-down of liquid foam reactants over the foam pieces, the pieces 25 become mobile and are integrated into the liquid foam and ultimately are dispersed in the foam core 4.

The advantage of introducing the foam pieces into the recesses or valleys 12 in the panel sheet 2 is that the pieces are captured within these recesses and are generally held in position. In view of this physical trapping of the pieces they do not generally interfere with the foam rise on heating to form the composite panel.

It is possible to deposit the foam pieces onto the flat section of the sheet 2 between the valleys/recesses 12. However, there is a risk that the laydown of the liquid foam reactants (which is generally through a traversing poker) could result in dragging of the foam pieces out of position. To alleviate this problem a binder may be used which is provided either on the sheet 2 in advance of foam lay-down and/or applied to the foam pieces. Alternatively, a fixed head may be used to apply a layer over the foam pieces. In another arrangement the foam pieces may be added after the main foam lay-down so that the foam is captured in the reacting foam mixture and is dispersed in the foam matrix.

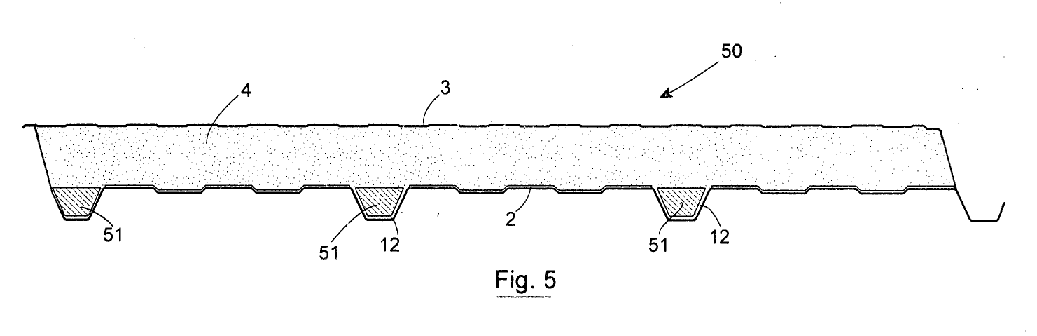

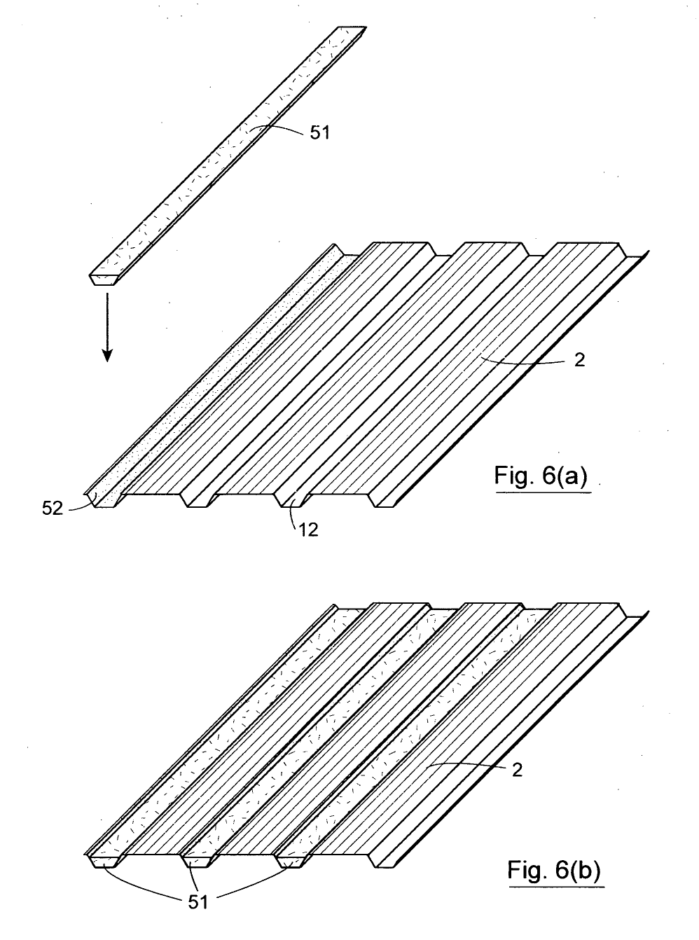

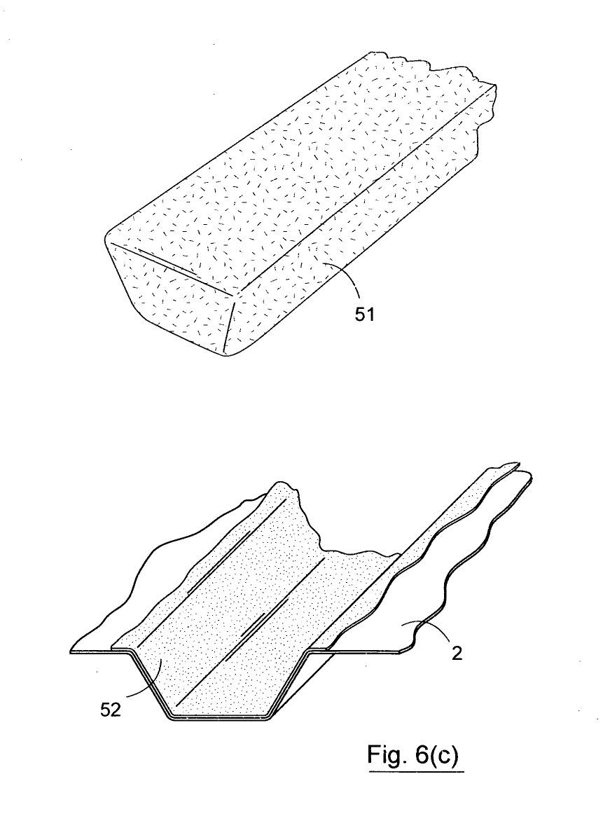

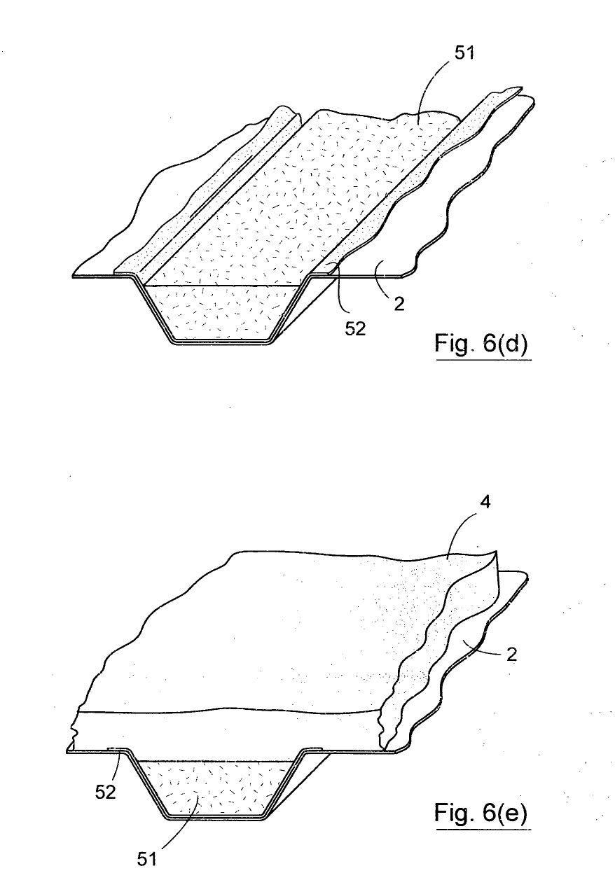

Referring to FIGS. 5 and 6, in another panel 50 foam pieces are formed into blocks or briquettes 51 which are incorporated into the panel. The blocks 51 may be of elongate form as illustrated or may be of shorter length and either spaced-apart or close together when deposited, in this case into some of the panel recesses/crowns 12. A layer 55 of adhesive/foam pre-laydown 3 may be provided on at least some of the inner walls of the recesses/crowns 12 to assist in bonding the briquettes 51 in situ prior to foam lay-down.

Any suitable binder may be used in forming the foam pieces into briquettes 51. The briquette forming process may involve one or more of heat or pressure during moulding.

There are several advantages of the invention. Waste is re-used leading to a reduction in disposal costs and reduction in manufacturing costs.

This technology can also be applied to recycle panels from old buildings. Such a recycle stream may be used separately or as an admixture with a recycling stream of production panels.

The panels of the invention may be used in a wide range of applications including wall panels, roof panels, or floor panels for buildings.

The invention is not limited to the embodiments hereinbefore described which may be varied in detail.

1-25. (canceled)

26. An insulating panel comprising a first sheet, a second sheet and an insulating foam core between the first and the second sheets, the insulating foam core comprising a main foam body and a recycled foam portion within the foam body.

27. The panel as claimed in claim 26 wherein the recycled foam portion is of substantially the same formulation as that of the main foam body.

28. The panel as claimed in claim 26 wherein the insulating core is a polyisocyanurate foam core.

29. The panel as claimed in claim 26 wherein the insulating core is a phenolic foam core.

30. The panel as claimed in claim 26 wherein the recycled foam portion comprises a plurality of foam pieces.

31. The panel as claimed in claim 30 wherein the foam pieces have an average dimension of from 5 to 25 mm.

32. The panel as claimed in claim 30 wherein the foam pieces have an average dimension of from 10 to 15 mm.

33. The panel as claimed in claim 26 wherein the foam pieces comprise pellets.

34. The panel as claimed in claim 26 wherein the recycled foam portion comprises a block or briquette.

35. The panel as claimed in claim 26 wherein at least one of the sheets is profiled to define at least one recess and the recycled foam portion is located at least partially in the recess.

36. The anel as claimed in claim 26 wherein the external and internal sheets have joint forming profiled portions.

37. The insulating panel as claimed in claim 26 wherein the first sheet is of sheet metal.

38. The insulating panel as claimed in claim 26 wherein the second sheet is of sheet metal.

39. A method for manufacturing an insulating panel of the type comprising a first sheet, a second sheet, and an insulating core of foam material therebetween; the method comprising the steps of:—
conveying a first sheet continuously along a bed;
laying down liquid foam reactants onto the first sheet;
leading a second sheet over the liquid insulating foam reactants; and
heating the assembly thus formed in an oven to allow the foam to expand to form an insulating core between the first and second sheets,
characterised in that a recycled foam portion is introduced prior to heating of the assembly in the oven.

40. The method as claimed in claim 39 comprising delivering the recycled foam portion to the first sheet and subsequently applying liquid foam reactants over the recycled foam portion.

41. The method as claimed in claim 39 wherein the recycled foam portion is applied after lay down of liquid foam reactants.

42. The method as claimed in claim 39 wherein the first sheet is profiled to define at least one recess and the recycled foam is delivered into the recess.

43. The method as claimed in claim 39 wherein the recycled foam portion comprises a plurality of foam pieces which are introduced to the first sheet.

44. The method as claimed in claim 43 wherein the recycled foam pieces are delivered from a hopper through a chute.

45. The method as claimed in claim 44 comprising the step of applying vibrational forces to the chute to assist free flow of the recycled foam.

46. The method as claimed in claim 39 wherein the recycled foam portion comprises a block or briquette which is introduced to the first sheet.

47. The method as claimed in claim 46 comprising the step of applying an adhesive means to at least portion of the fist sheet and applying the block to the adhesive means.
